(19) United States
(12) Patent Application Publication
(10) Pub. No.: US 2025/0271827 A1
(43) Pub. Date: Aug. 28, 2025

(54) SUPERORDINATE BEHAVIOR DESCRIPTION FOR GENERATING A CONTROL PROGRAM AND CONFIGURATION FOR AN AUTOMATION DEVICE

(71) Applicant: WAGO Verwaltungsgesellschaft mbH, Minden (DE)

(72) Inventor: Daniel JEROLM, Bad Essen (DE)

(73) Assignee: WAGO Verwaltungsgesellschaft mbH, Minden (DE)

(21) Appl. No.: 19/065,209

(22) Filed: Feb. 27, 2025

(30) Foreign Application Priority Data
Feb. 27, 2024 (DE) 10 2024 105 535.9

(51) Int. Cl. G05B 19/042; G06F 8/30

(52) U.S. Cl. CPC G05B 19/0426; G06F 8/313; G05B 2219/23039

(57) ABSTRACT

Provided are methods, devices/apparatus and computer programs for configuring a programmable automation device. The method includes receiving a user-defined behavior description for defining a runtime behavior of the automation device and automatically generating a control program and a configuration for the automation device based on the behavior description. The control program and configuration may then be used for resource-saving operation of automation devices.

This nonprovisional application claims priority under 35 U.S.C. § 119 (a) to German Patent Application No. 10 2024 105 535.9, which was filed in Germany on Feb. 27, 2024, and which is herein incorporated by reference.

### BACKGROUND OF THE INVENTION

### Field of the Invention

The present invention relates generally to the technical field of automation technology, in particular in building automation. The present invention particularly relates to automation devices which determine output signals based on specific input signals and, for example, a control program, and which output or otherwise provide these output signals.

### Description of the Background Art

In automation technology, control systems are often used. Such systems may comprise automation devices to, for example, control certain components. The automation devices are often already configured to provide basic functionalities based on so-called firmware. However, before they can be used for specific purposes (“in the field”), they must typically be programmed first. Depending on certain factors (relevant factors that may be exemplarily mentioned are: task of the device, position of the device within an overall system), the required programming may differ. In many cases, programming must therefore be carried out by a user or programmer on a device-specific basis. Such required programming is often complex, error-prone and inflexible. Even simple changes or the correction of individual errors may generate considerable additional effort.

As an example, a classic programming of a device may be considered. Therein, a high-level language (higher programming language with a high level of abstraction, e.g., C, C++) may be used. Such a high-level language has the advantage that programming at a high level of abstraction is possible, i.e., that complexities (compared to programming at machine code level or the processes taking place during execution at CPU level) are reduced by the availability of high-level instructions in the program code. Compilers may be used to convert program code from such high-level language into machine language, which may then be accessible to immediate execution. Alternatively, runtime environments (e.g., runtime interpreters) may be used. The procedures are complex and require a lot of resources. Often, negative effects on runtime performance can often be observed.

Another example involves the use of programmable logic controllers (PLCs). A variant for programming the PLCs is provided by the Controller Development System (Codesys). Programmable logic controllers may be programmed using an integrated development environment (IDE). Here, too, a complex compilation and/or a more computationally complex execution, for example a runtime interpretation, may be necessary which requires a high level of resources.

Furthermore, script languages are known which may be used to program automation controls. Programs for programmable logic controllers may then be put together by the programmer using the respective scripting language. If necessary, the program instructions may be translated into a kind of intermediate and/or byte code before execution, before execution of an automation component on a CPU can be achieved using the firmware.

The known solutions have the disadvantage that the resource requirements are enormously high. Finally, it is necessary to compile and/or interpret at runtime. In addition to the high resource requirements, this complexity also results in a high susceptibility to errors. This often makes it difficult to detect and/or pinpoint errors. For example, errors can be traced back to an actual program and/or compilation errors, but most often to errors (e.g., programming errors but also other forms of execution errors) in the runtime environment. Error tracing is therefore difficult, and many errors remain undetected for a long time. In particular, rarely occurring errors may manifest themselves in the automation products in this way. Instead of correcting the errors, their occurrence at a certain probability is accepted. In this case, the systems do not run stable long-term, but only for a longer period until an error-related anomaly occurs, making a system restart necessary, for example. This is particularly unwanted for applications for which limited resources are available in the field and restarting or troubleshooting is only possible under difficult conditions.

In order to make runtime environments available for small microcontrollers, they have often been further restricted in their functional repertoire as well as in their performance characteristics. This further complicates efficient debugging of user programs for automation components.

The use of compilers and IDEs also regularly requires the complex use of additional external computer resources, especially in scenarios where, for resource reasons, powerful microcontrollers are to be avoided when using automation components “in the field”.

The solutions mentioned may all be unsatisfactory in terms of a flexible and resource-saving solution that can be programmed and operated. In this context, significantly simpler and more confidence-instilling debugging by the user is also highly desirable.

### SUMMARY OF THE INVENTION

It is therefore an object of the present invention to overcome the the above-mentioned disadvantages, by providing a resource-saving and energy-saving and at the same time more effective and practical solution for configuring and operating automation devices than those existing in the state of the art.

In its most general form, the present invention provides methods, apparatus, systems and computer programs for configuring and successively successfully operating programmable automation devices. The methods described may be computer-implemented.

According to an example of the present invention, a method for configuring a programmable automation device may be provided. The method may comprise receiving a user-defined behavior description for defining a runtime behavior of the automation device. The method may comprise automatically generating a control program and a configuration for the automation device based on the behavior description. The method may also comprise providing the control program and the configuration. Operating one or more appropriately programmed automation devices may also be envisaged.

The control program and the configuration of the building automation device may together define the functionality that the automation device provides. Both may work together, but it may be differentiated between them.

The behavior description (to which both, the configuration and the control program, are subordinate) describes, for example, what one or more automation devices should do when, for example, a certain event occurs in the field. For instance, a specific input signal (e.g., operating a light switch) may result in a specific output signal (e.g., for controlling a light source) being activated for a certain period of time.

The superordinate behavior description may be in a format that is optimized for the needs of a tool for entering and editing the behavior description (e.g., a PC tool, see also FIG. 6) for an automation device or for a system formed of several automation devices. This format may be unsuitable for direct execution by a microcontroller or an interpreter.

The present superordinate behavior description may, for example, be translated by a translator into a control program and a configuration for the building automation device. The translated control program may then be available, for example, as byte code that may be processed by an interpreter. The translator may run on the automation device, another device, or in a cloud. The location of the translation may be particularly dependent on effort (and thus resource dependent). The control program and the configuration may be checked for validity by the automation device before both are used to generate the desired runtime behavior of an automation device, as will be explained in more detail below. The control program and configuration may be persistently stored in the automation device so that they are immediately available again after a power failure. In larger automation systems, a head station may be used, which may assume a superordinate role over various other automation components. In this case, additional copies of the control programs and/or the configurations of the components may be persisted in the head station. These copies may then be used, for example, in the event of a failure of the local component or in the event of a failure of only the local copy, as well as, for example, if a replacement of a local component by an equivalent model should become necessary due to a defect.

The control program of the building automation device may, for example, link inputs and/or outputs to each other and/or to functions stored in the firmware of the device. The control program may, for example, include instructions according to the following pattern:
“If condition true, then action, further action, further action, . . . ”
This can be illustrated by the following example:
“If light button==pressed, then light_OnOff: =NOT light_OnOff”

In formulating the condition and the action(s), simple logical operations such as NOT, AND, OR may be supported. It may also be supported that the condition contains various comparison operators such as ==, !=, >, <.

The representation of these logical operators in written form within this document is only symbolic and shall be non-restrictive as to its scope. The invention is based only on the technical teaching itself and not on a convention for the notation of the technical teaching.

An action may comprise assigning a value to a variable. The value may include a constant or may also be formed from one or more variables by a logical operation.

The advantages of this solution include, in particular, low complexity, low resource requirements during use (especially on the automation component, especially when used in the field; this allows the use of smaller, less powerful and more economical microcontrollers), low resource requirements during compilation, ability to test the control program in advance for validity or errors (in particular, errors that would cause undefined behavior and/or crashes of the automation component may be excluded in advance). The energy requirement is low, especially when used in the field. The event-driven approach saves additional resources, especially energy, transmission and computing capacity. The “modular principle” provides the user with more flexibility, overview and control. In particular, less “programming” in the classic sense is required on the user side, as more emphasis is placed on “configuration activities” by the user instead of classic “programming activities”.

Further advantages of the invention result, for example, from the simplicity of the control program. The control program may include if-then-statements. In an example, the control program may only comprise If-then-statements. For example, conditions may only affect the actions in the respective statement (no If-“block statements”). For example, no goto statements may be available. For example, no functions and/or function calls may be available. In an example, the simplicity is further increased by only one action statement being permitted per if-then-statement. In general, however, several actions may be listed for successive execution.

The conditions of a statement may be evaluated, for example, if at least one variable referenced by the condition has changed at least once since the condition was last evaluated. There will hence be no sequential processing, rather those instructions whose input variables have changed are executed. This saves computing resources. If several statements must be evaluated, the order may be undefined. This provides further flexibility with regard to execution and also allows parallelization of executions of different components of the control program, even simultaneously, especially for automation devices that have several MCUs.

It should be noted that the possibilities for making a functionality available via the control program may be limited in favor of the simplicity of the control program. Complex functions may instead be provided by the device's firmware. Also, a selection of functions may be linked together via the control program.

The simplicity of the control program allows the automation component to fully test the control program for validity before use. The quality of and absence of errors in the complex functions provided by the device's firmware may be ensured inter alia by the manufacturer, e.g., through reviews and unit tests.

The variables referenced by the control program (e.g., “light switch” and “light_OnOff” in an example, see example above) may, for example, be inputs or outputs of the automation device, or input and/or output variables of a complex function provided as part of a firmware.

Instead of the user implementing a timer for a staircase lighting function himself/herself, as he/she might do on a conventional device in an IEC language, one or more such timers may be available as part of the firmware of the device. They may be started and evaluated, for example, through variables that may be referenced and linked together by the control program. This will be explained in more detail in the context of a very simple example in the figure description.

A configuration of the building automation device may, for example, be viewed as a classic parameterization. The control program and the configuration may together determine the behavior of the device.

In addition, the configuration may include settings that determine which functions that are hard-coded in the firmware are actually made available to the control program and in what quantity. For example, the firmware may include a number of classes (templates) for functions, but the configuration may provide only the set of functions that are actually required for the application. This approach is advantageous in that MCUs usually have a relatively large flash memory (for templates/classes) but rather little RAM (for instantiating the templates/classes that are actually to be used). This means that a cheap MCU with little RAM may be used and still offer a wide range of hard-coded building automation functions to choose from, since usually only a few functions are selected and used by real control programs at any one time.

In complicated systems in which control programs and configurations for several system components (including automation devices) are provided from a behavior description, the templates or the functions provided locally for a specific component may also be determined by a (higher-level) task distribution strategy, which may form part of the behavior description for the system. For example, optimization may be carried out using simple and system-global methods, depending on the respective computing and storage capacities of the specific hardware components used. This will be described in more detail below.

In a simple example, a configuration may define a hold time of a timer. The configuration may also, for example, configure a special behavior of a timer: For example, a certain (e.g. predefined) time before the expiration of a timer, a controlled device (e.g., a light bulb) may be switched off briefly and then switched on again in order to give advance notice of the final switch-off (of the lighting). This is just a concrete, but by no means limiting, example of an application.

A superordinate behavior description may also be provided, for example, for several automation devices, in particular automation systems comprising several automation devices. Such a superordinate behavior description, which covers the behavior of several components of a system, may be translated into control programs and configurations. When translating such a cross-device and/or cross-system superordinate behavior description, a configuration and a control program may be generated and provided for each component. In particular, such a system may have a head station and the I/O modules of a modular I/O system. Expanders and other I/O modules may also be included in such a system. In addition to the advantages already mentioned, such a superordinate behavior description across devices and/or systems also ensures the consistency and the desired harmonious interaction of the individual system components.

In this context, a hard-coded function may also be conceivable that offers a series of variables for linking, and mirrors these in one or more other automation devices that are connected to the current automation device via a bus. Such a combination may, in particular, be a head station and/or expander and/or the IO modules of a modular I/O system. Such mirroring may, for example, be based on a subscription principle. For example, an outgoing data value from a first automation device may be entered into a data input of a second automation device, for example by means of a local and/or field bus.

After translation, the individual system components may behave with a high degree of autonomy (in particular, independently of the superordinate behavior description). This means that if a component fails, most of the system functions will still be available.

In a non-limiting example comprising a head station and I/O modules connected to the head station via a bus, the head station may, for example, provide local functions of the head station as well as other functions that span multiple I/O modules, provided by appropriate translation of a superordinate behavior description. Functions that only affect individual I/O modules locally may be handled independently by the respective individual I/O modules. These may therefore be adopted when compiling the control program and configuring the corresponding I/O module. This has numerous structural advantages in terms of simplicity, structure, energy requirements and the aforementioned subsystem autonomy. For example, if a bus connection fails, the IOM local functions may still be available. Low energy consumption results from the fact that a significant portion of the events can be processed locally within the IOM and less interaction with other components is required.

A control program may be provided in a byte code, which allows for a good compromise between flexibility and abstraction for the application case. However, this should in no way limit the present invention. As an alternative to translating the control program into a byte code, the control program could also be translated into machine code that may be executed directly by the CPU. An alternative would be to translate the byte code into machine code (two successive translations).

In an example of the present invention, a data processing apparatus is provided. The apparatus comprises, for example, a processor and memory, for carrying out the method according to any examples disclosed herein. The apparatus may be a data processing apparatus which is assigned to a user as described above, like a client, and may be configured to carry out the corresponding steps. The apparatus may be a data processing apparatus which is assigned to a cloud computing environment as described above, like a server, and may be configured to carry out the corresponding steps.

In an example of the present invention, a computer program is provided. The computer program comprises instructions which, when executed by a computer, cause the computer to carry out the method according to any examples disclosed herein.

Although some examples have been described with regard to an apparatus, it is clear that these examples also represent a description of the corresponding method, wherein a block or an apparatus corresponds to a method step or a function of a method step. Analogously, examples described with regard to a method step also represent a description of a corresponding block or element or a property of a corresponding apparatus.

Examples of the invention may be implemented in a computer system. The computer system may be a local computing device (e.g., personal computer, laptop, tablet computer, or mobile phone) having one or more processors and one or more storage devices, or may be a distributed computing system (e.g., a cloud computing system having one or more processors or one or more storage devices distributed across different locations, for example, a local client and/or one or more remote server farms and/or data centers). The computer system may include any circuit or combination of circuits. In an example, the computer system may include one or more processors, which may be of any type. As used herein, processor may mean any type of computing circuit, such as, but not limited to, a microprocessor, a microcontroller, a complex instruction set microprocessor (CISC), a reduced instruction set microprocessor (RISC), a very long instruction word (VLIW) microprocessor, a graphics processor, a digital signal processor (DSP), a multi-core processor, a field-programmable gate array (FPGA), or any other type of processor or processing circuit. Other types of circuitry that may be included in the computer system may be a custom-built circuit, an application specific integrated circuit (ASIC), or the like, such as one or more circuits (e.g., a communications circuit) for use with wireless devices such as cellular phones, tablet computers, laptop computers, two-way radios, and similar electronic systems. The computer system may include one or more storage devices, which may include one or more storage elements suitable for the particular application, such as a main memory in the form of a random access memory (RAM), one or more hard disks, and/or one or more drives containing removable media, such as CDs, flash memory cards, DVDs and the like. The computer system may also include a display device, one or more speakers, and a keyboard and/or controller, which may include a mouse, trackball, touch screen, voice recognition device, or any other device that allows a system user to enter information into and receive information from the computer system.

Some or all of the method steps may be carried out by (or using) a hardware device, such as a processor, a microprocessor, a programmable computer, or an electronic circuit. In the examples, one or more of the key method steps may be carried out by such a device.

Depending on particular implementation requirements, example of the invention may be implemented in hardware or software. The implementation may be carried out with a non-volatile storage medium such as a digital storage medium such as a floppy disk, a DVD, a Blu-Ray, a CD, a ROM, a PROM and EPROM, an EEPROM or a FLASH memory on which electronically readable control signals are stored that interact (or may interact) with a programmable computer system to carry out the respective method. Therefore, the digital storage medium may be computer-readable.

The examples of the invention may comprise a data carrier with electronically readable control signals that may interact with a programmable computer system such that one of the methods described herein is carried out.

In general, examples of the present invention may be implemented as a computer program product having a program code, wherein the program code is effective for carrying out one of the methods when the computer program product is running on a computer. The program code may, for example, be stored on a machine-readable medium.

Further examples include the computer program for carrying out one of the methods described herein, which is stored on a machine-readable data carrier.

In other words, an example of the present invention is thus a computer program with a program code for carrying out one of the methods described herein when the computer program runs on a computer.

A further example of the present invention is therefore a storage medium (or a data carrier or a computer-readable medium) comprising a computer program stored thereon for carrying out any of the methods described herein when executed by a processor. The data carrier, the digital storage medium or the recorded medium are usually tangible and/or non-volatile. A further example of the present invention is an apparatus as described herein comprising a processor and the storage medium.

A further example of the invention is therefore a data stream or a signal sequence representing the computer program for carrying out one of the methods described herein. For example, the data stream or signal sequence may be configured to be transmitted over a data communication connection, for example over the Internet.

A further example includes a processor, for example a computer or a programmable logic device, configured or adapted to perform any of the methods described herein.

A further example comprises a computer on which the computer program for carrying out one of the methods described herein is installed.

A further example of the invention comprises a device or system configured to transmit (e.g., electronically or optically) a computer program for carrying out one of the methods described herein, to a receiver. The receiver may be, for example, a computer, a mobile device, a storage device or the like. The device or system may, for example, comprise a file server for transmitting the computer program to the receiver.

A programmable logic device (e.g., a field programmable gate array, FPGA) may be used to perform some or all of the functionality of the methods described herein. A field programmable gate array may cooperate with a microprocessor to perform any of the methods described herein. In general, the methods are preferably carried out by each hardware device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary system, in particular for building automation, in which an example of the present invention may be deployed;

FIG. 2 shows a schematic representation of the generation of a control program and a configuration for a single automation device, both based on a superordinate behavior description created by the user;

FIG. 3 shows an exemplary implementation of a timer by a control program and a configuration within the framework of an interconnection of functions via variables and if-then-statements;

FIG. 4 shows An exemplary schematic representation of the generation of control programs and configurations for several components of an overall system;

FIG. 5 shows an exemplary schematic representation of an interactive interaction of different components of a system with distribution of local functions to I/O modules and a head station and assignment of cross-module functions to a head station to form a complete overall system function; and

FIG. 6 shows an exemplary user interface (GUI) for setting up a superordinate behavior description by a user by “configuring” the GUI.

### DETAILED DESCRIPTION

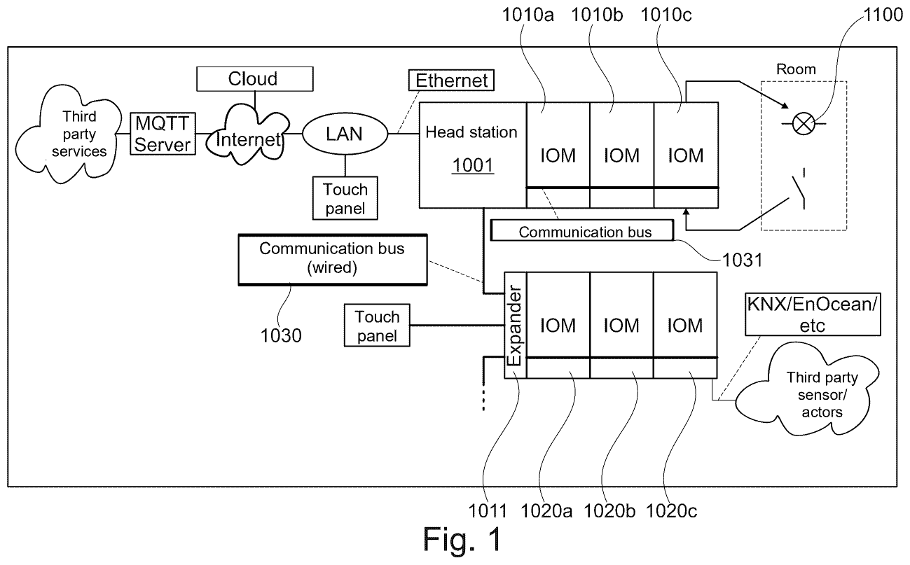

FIG. 1 shows an exemplary system in which an example of the present invention may be deployed.

There is shown an exemplary infrastructure which allows, for example, to automate and/or remotely control elements of a room, a floor and/or a building. The system comprises one or more head stations 1001 and input/output modules (IOMs) 1010a-c, which are arranged next to one another, for example, on a mounting rail. Communication between these elements may occur via a suitable communication bus 1031. Furthermore, the system comprises expanders 1011. The expanders may group multiple IOMs 1020a-c. The expanders 1011 (including their associated IOMs) may, in particular, be located at physically separate locations, in particular with respect to the head station 1001 with which they may communicate via a communication bus, in particular a wired communication bus 1030.

For example, buttons, switches, sensors, sockets, lamps 1100 and/or actuators 1100 may be connected to the IOMs 1010a-c, 1020a-c (the depicted number of three IOMs each being merely exemplary and in no way limiting) and thus controlled by the system. The IOMs thus form an interface to the field.

The IOMs 1010a-c, 1020a-c may be provided with local control capabilities. These local control capabilities enable, for example, switching operations and functions that only involve sensors and actuators connected to the IOM 1010a-c, 1020a-c to be controlled autonomously by the IOM 1010a-c, 1020a-c without requiring interaction with the rest of the system. This reduces the system's own energy consumption and increases availability, because the functions implemented by the IOMs 1010a-c, 1020a-c are available independently and reliably even in the event of a fault in other parts of the system (e.g., a failure of the head station).

The head station 1001 (or in part the local expander 1011) is responsible for functions that cannot be implemented locally by a single IOM 1010a-c, 1020a-c. In contrast to conventional systems, there is no cyclical/periodically recurring communication between head station 1001 (or local expander 1011) and IOMs 1010a-c, 1020a-c. Instead, communication only occurs when an event has occurred that requires involvement of the head station 1001/the expander 1011. During periods when no events occur and no communication takes place in the system, all components are in power saving mode.

Especially with IOMs 1010a-c, 1020a-c, this may lead to an almost complete shutdown of the component, which helps to enormously reduce energy consumption in numerous application situations.

Further optimizations to reduce energy consumption may also be pursued.

For example, the head station 1001 (or the expander 1011) may be configured to differentiate in which communication bus segment there are changes and to wake up and query only these IOMs 1010a-c, 1020a-c from the energy saving mode. IOMs 1010a-c, 1020a-c in segments not affected by the event may remain undisturbed in power saving mode.

Furthermore, it may be envisaged that when writing back changing output data to the IOMs 1010a-c, 1020a-c, only those IOMs 1010a-c, 1020a-c are woken up from the energy saving mode whose outputs actually need to be updated.

The user does configure but not program the system. This may be done via a graphical user interface.

Preferably, simple control programs are used, for example as an executable end result of a corresponding configuration, which include instructions of the type “if X then do Y” (or are composed exclusively of them). Independence/permutability between the individual instructions of a control program may also be ensured. For example, the program may be executed with a deterministic result, wherein the execution order of the individual instructions does not matter (or alternatively is, or needs to be, only partially restricted). This allows for flexibility in execution and parallelization.

These and further optimizations contribute to the system's low energy requirements and energy consumption.

In addition to implementing IOM-wide functions, the head station 1001 may also be configured as a gateway to the “outside world”.

The head station 1001 may establish a connection to a cloud service and obtain the configuration for the system from the cloud service and distribute the configuration to itself and to the IOMs 1010a-c, 1020a-c.

Furthermore, the head station 1010a-c, 1020a-c stores the complete configuration persistently in the head station to enable the replacement of defective IOMs even without a connection to the cloud.

Furthermore, the IOMs 1010a-c, 1020a-c persist their configuration in order to provide the functions implemented locally by the IOMs in the event of a fault (e.g., failure of the head station 1001) after an interruption of the electrical power supply (power failure). The head station 1001 may establish a connection to a (e.g. WAGO) server (which may be part of the cloud) and regularly receive firmware updates for itself and the components of the system. In return, the head station 1001 may be configured to upload logs (reports/error logs) with error and crash reports in the event of an error.

The head station 1001 preferably provides for a connection to an MQTT server for the exchange and interaction with third-party services, systems and devices.

It is also possible to connect the 1001 head station to proprietary and/or open standards (e.g. MATTER).

The system is quite energy-efficient, decentralized, autonomous and self-sufficient and, as a result, extremely robust.

A communication bus may be a wired communication bus, in particular a backplane bus on a DIN rail. The communication bus may allow for a serial connection with a transfer rate of, for example, 250 kbit/s.

A communication bus may alternatively or additionally be a wireless communication bus, in particular provided by an RS-485 connection (for example with 250 kbit/s). The electromagnetic compatibility is ideal for the desired robustness of the system. In addition to the data connection, a supply voltage for the remote device may also be transmitted optionally.

A 4-wire cable, such as that used in a KNX field bus, has proven to be particularly suitable for a wired communication bus.

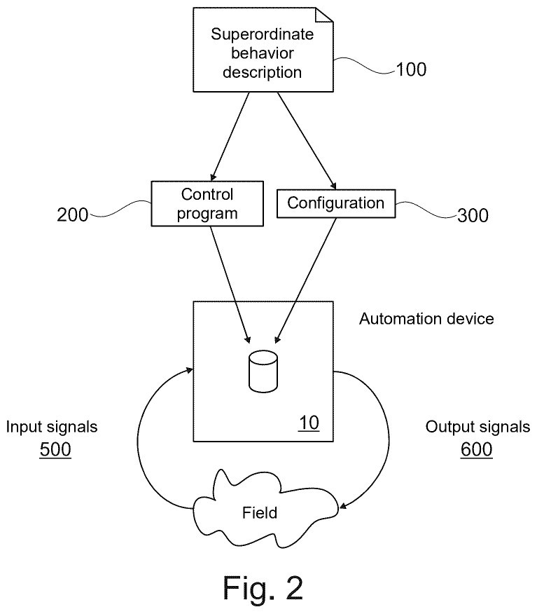

FIG. 2 shows a schematic representation of the generation of a control program 200 and a configuration 300 for a single automation device 10, both based on a superordinate behavior description 100 created by the user.

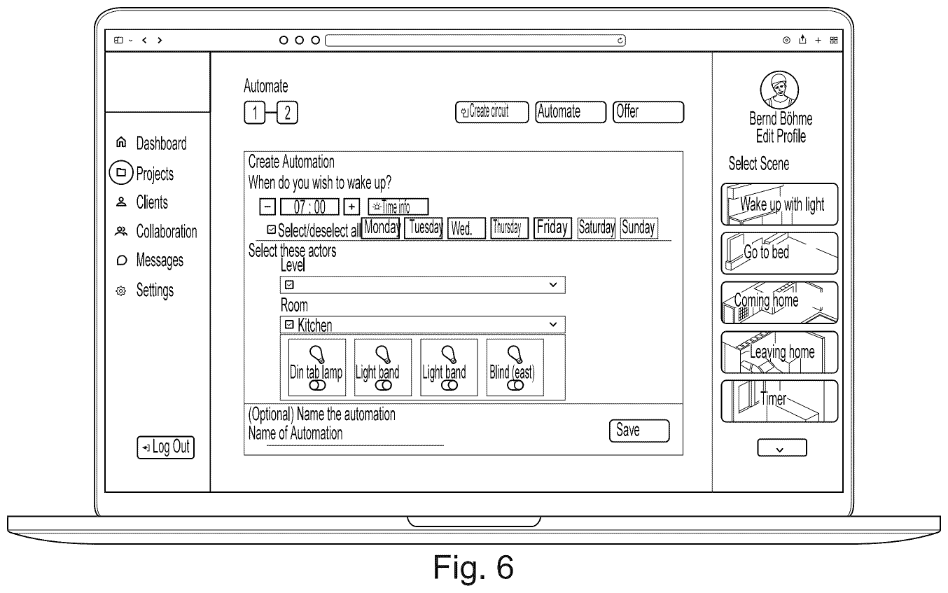

A superordinate behavior description 100 can be generated, directly or indirectly, by a user. For example, this may be done using the graphical user interface (GUI) of FIG. 6. The behavior description 100 may not be directly executable by automation device 10. For runtime execution on the automation device 10, the superordinate behavior description 100 is converted into a control program 200 and a configuration 300. The control program 200 may, for example, formed exclusively of single-line, mutually permutable, simple if-then statements. The translation of the superordinate behavior description 100 for generating the control program 200 and the configuration 300 may, for example, be carried out on a computer, in a cloud, or on a microprocessor of the automation device 10. The three non-limiting examples mentioned here each have their own advantages. The preferred choice may, for example, depend on the given performance characteristics of the hardware used. For example, translation may also be performed on a head-end station, wherein control programs 200 and configurations 300 are generated for the I/O modules connected to the head-end station.

An automation device 10 may be configured to receive input signals 500 and provide output signals 600 during runtime operation. In this context, the automation device 10 uses its configuration 300 and its control program 200. The configuration 300 and control program 200 therefore influence the output signals 600 provided in a specific case. The input and/or output signals may be, for example, electrical, optical and/or electromagnetic signals.

This solution provides a simple and resource-efficient automation solution with the desired flexible features. The behavior defined by the user in the behavior description 100 is provided by the automation device 100 during runtime.

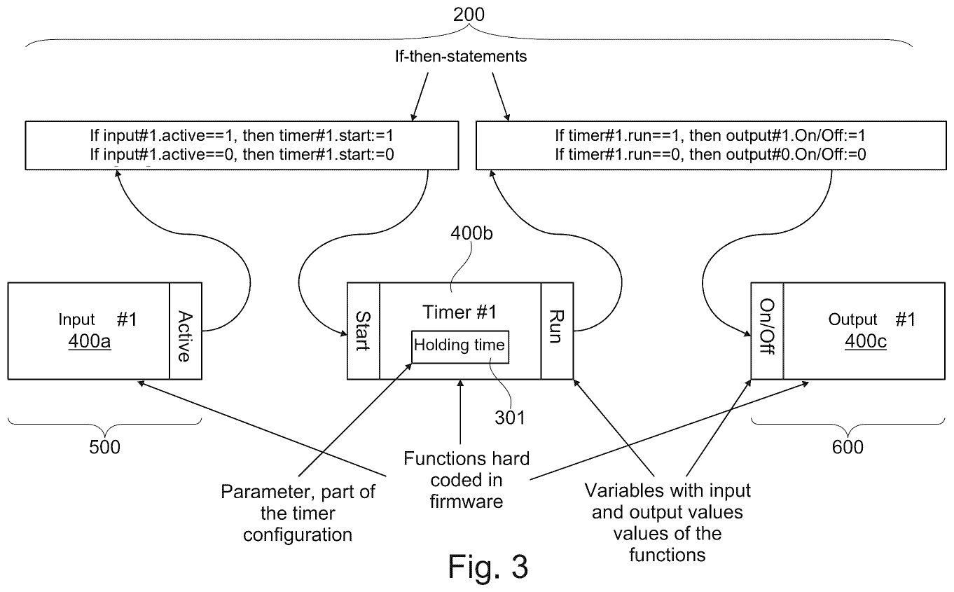

FIG. 3 shows an exemplary implementation of a timer by a control program 200 and a configuration 300 by interconnecting functions via variables and if-then statements.

The control program 200 includes, as an example, the simple if-then statements shown here. Certain hard-coded functions 400a-c may, for example, be provided by a device firmware of an automation device 10. For example, these functions include retrieving 400a a specific value of an “Input #1” which is available at the automation device 10 due to an incoming signal 500 and/or is otherwise available. For example, these functions include setting 400c a specific value of an “Output #1” which is provided via an outgoing signal 600 from the automation device 10.

A timer (timer/timer) 400b may be provided by the illustrated instructions of the control program. A desired holding time 301 of the timer 400b is taken, for example, from a configuration 300 of an automation device 10. The abstract timer function 400b is provided, for example, by the device firmware of the automation device 10.

As should be emphasized at this point, this is only a very simple example. The described examples may be used to generate much more complex interactions (including timer structures). In particular, only an execution of simple control programs 200 with simple one-line if-then statements is required for execution by the automation device 10.

The control programs 200 may be tested particularly easily, especially before the first actual execution, for bugs, crashes, and/or causing uncontrolled behavior of the automated devices.

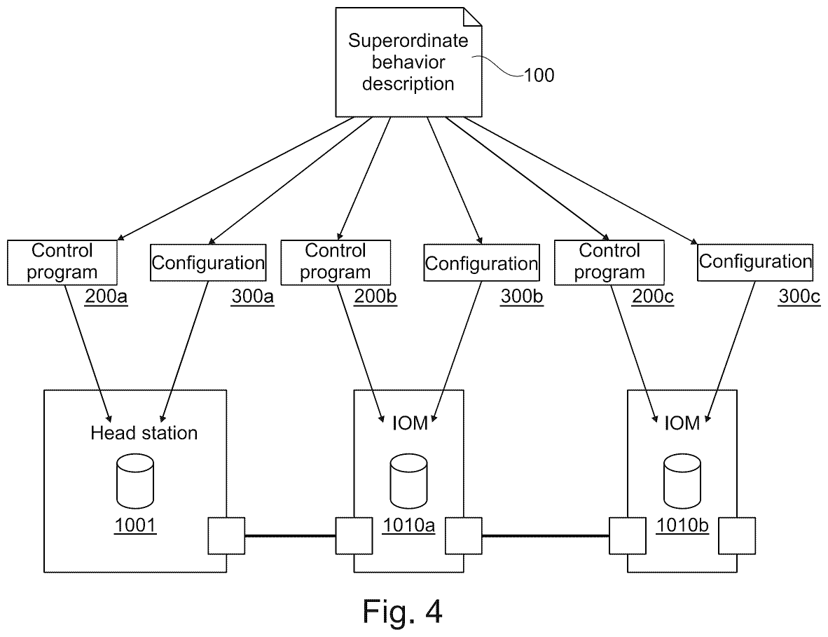

FIG. 4 shows an exemplary schematic representation of the generation of control programs and configurations for several components of an overall system.

The exemplary overall system comprises a head station 1001 with two exemplary I/O modules 1010a and 1010b, which may be connected to each other via a bus. Thus, several consistent configurations 300a, 300b and 300c as well as control programs 200a, 200b and 200c are generated from a single consistent behavior description 100. As is inherent in the process, the individual configurations 300a-c and control programs 200a-c are necessarily adapted to one another. The runtime behavior of the resulting overall system is therefore less susceptible to errors with regard to the interactions between the components and is therefore extremely stable, predictable, and reliable in a system-immanent manner. In addition, possible errors may be more easily “traceable”, i.e., traced back to their root cause.

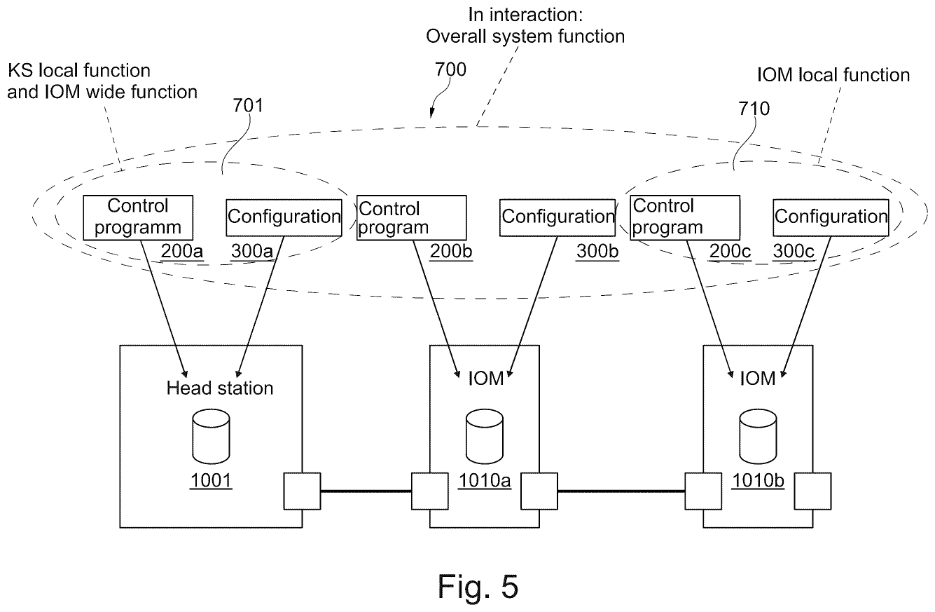

FIG. 5 shows an exemplary schematic representation of an interactive interaction of different components of a system with local functions being distributed across I/O modules and a head station and with cross-module functions being assigned to a head station to form a thorough overall system function.

A preferred distribution of tasks in the depicted system is as follows: Local functions of the head station 1001 as well as cross-module or cross-system functions 701 are taken over by the head station 1001 or assigned to the head station 1001 when translating the behavior description and generating the control programs 200a-c and configurations 300a-c. This may be resource-efficient, as the I/O modules can often be equipped with less powerful and more energy-efficient processors. In the depicted example, only I/O module-local functions 710 are assigned to the I/O modules 1010a and 1010b or are performed by these modules during system runtime. In another example, a desired distribution of different task types to the system components may be defined within the framework of a superordinate behavior description (in a simple and/or system-global manner). Through translation, this is incorporated into the control programs 200a-c and configurations 300a-c, wherein resources are saved (for example, no unnecessary functions are provided locally anywhere or even loaded into the main memory). The correct system functionality is guaranteed, since the exact coordination of the individual control programs 200a-c and configurations 300a-c is already inherent in the system and procedure. In particular, even after the functionality of the system has actually been “configured”, resource and hardware may further be optimized without the user having to attend to larger and more complex changes manually.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for configuring a programmable automation device, the method comprising:
receiving a user-defined behavior description for defining a runtime behavior of the automation device;
automatically generating a control program and a configuration for the automation device based on the behavior description; and
providing the control program and the configuration.

2. The method of claim 1, wherein the behavior description is received in a form which is not directly executable by a microcontroller and/or interpreter.

3. The method of claim 1, wherein the control program is executable on a firmware of the automation device.

4. The method of claim 1, wherein the generated control program comprises at least one instruction.

5. The method of claim 4, wherein the at least one instruction links one or more inputs of the automation device and/or one or more outputs of the automation device and/or one or more functions provided by the automation device.

6. The method of claim 4, wherein the at least one instruction is an if-then statement defining at least one condition and at least one action.

7. The method of claim 6, wherein the control program only includes if-then-statements.

8. The method of claim 4, wherein the at least one instruction, or the entire control program, is free of: if-statements, goto-instructions and/or function definitions.

9. The method of claim 4, wherein the at least one instruction is executed event-based.

10. The method of claim 1, further comprising:
checking the control program and/or the configuration before executing the control program.

11. The method of claim 1, wherein the configuration defines at least one value of a variable which the control program is able to use.

12. The method of claim 1, wherein the automation device provides a plurality of callable functions by a firmware of the automation device, and wherein the configuration indicates a subset or a proper subset of the plurality of callable functions which are made available to the control program.

13. The method of claim 1, wherein the control program is generated in bytecode which is executable by an interpreter running on the automation device, or wherein the control program is generated in machine code which is executable by a processor of the automation device, or wherein the control program is first generated in bytecode and the bytecode is then translated into machine code which is executable by a processor of the automation device.

14. The method of claim 1, wherein the behavior description is a behavior description for defining a runtime behavior of a plurality of automation devices, and wherein the step of automatically generating provides a control program and a configuration for each of the plurality of automation devices.

15. The method of claim 1, wherein the method is carried out by the automation device, and wherein the step of providing the control program and the configuration comprises storing them in a memory of the automation device.

16. The method of claim 1, wherein the method is carried out by a data processing apparatus, and wherein the step of providing the control program and the configuration comprises a data transfer to the automation device.

17. A method for operating a programmable automation device, the method comprising:
providing a control program and a configuration that has been generated by the method according to claim 1; and
executing the control program using the configuration.

18. An automation device or a data processing apparatus configured to carry out the method according to claim 1.

19. An automation system, a non-time-critical automation system, or a building automation system, which comprises at least one automation device according to claim 18.

20. A computer program or a computer-readable medium on which the computer program is stored, wherein the computer program comprises instructions which cause an automation device or a data processing apparatus to carry out the method according to claim 1.
